(19) United States
(12) Patent Application Publication
(10) Pub. No.: US 2024/0330883 A1
(43) Pub. Date: Oct. 3, 2024

(54) METHOD FOR ADVANCED DIRECT RECORDING AND STREAMING OF DIGITAL CONTENTS ASSOCIATED WITH PRODUCTS OR DIGITAL ASSETS USING UNIQUE IDENTIFICATION

(71) Applicant: Angelica Figueiredo White, Johns Creek, GA (US)

(72) Inventor: Angelica Figueiredo White, Johns Creek, GA (US)

(21) Appl. No.: 17/736,093

(22) Filed: May 4, 2022

Related U.S. Application Data
(63) Continuation-in-part of application No. 14/537,888, filed on Nov. 10, 2014.
(63) Continuation-in-part of application No. 17/719,701, filed on Apr. 13, 2022.
(60) Provisional application No. 63/184,156, filed on May 4, 2021.
(60) Provisional application No. 63/184,788, filed on May 6, 2021.
(60) Provisional application No. 63/194,185, filed on May 28, 2021.

(51) Int. Cl. G06Q 20/12; G06K 7/14; G06Q 20/32

(52) U.S. Cl. CPC G06Q 20/1235; G06K 7/1417; G06Q 20/3276

(57) ABSTRACT

This invention allows for the direct recording and streaming of digital contents from products or digital assets through their association with unique identifications encoded using visible or concealed technologies such as Barcode, QR Code, Datamatrix, Near Field Communication (NFC)) tags, ZARImage, and other technologies leveraging AI Intelligent Imaging Processing and Optical Character Recognition (OCR) technologies to encode and decode unique identification. The unique identifications used by this invention can be, but not limited to these types: ZARCode, NFT (Non-Fungible Token), Uniform Resource Locator (URL) and Uniform Resource Identifier (URI). It also provides a method for showing engagement options to digital contents associated with products or digital assets shown on mobile device media player.

### REFERENCES

Ser. No. 14/537888, Ser. No. 17/719701, 63/184156, 63/184788, 63/194185

### FIELD OF THE INVENTION

### Technology, Internet of Things, Mixed Reality

This invention allows for the direct recording and streaming of digital contents from products or digital assets through their association with unique identifications encoded using visible or concealed technologies such as Barcode, QR Code, Datamatrix, Near Field Communication (NFC) tags and ZARImage, and other technologies leveraging Artificial Intelligence (AI) Imaging Processing and Optical Character Recognition (OCR) technologies to encode and decode unique identification. This invention can use, but not limited to, unique identification types such as ZARCode, Non-Fungible Token (NFT), Uniform Resource Locator (URL) and Uniform Resource Identifier (URI). It also provides a method for showing engagement options to digital contents associated with products or digital assets shown on mobile device media player.

### Background of the Invention

This invention is in the field of Internet of Things and Mixed Reality. The exponential growth of digital contents, user generated digital contents created a challenge and opportunity for how the physical and digital world can connect. As video content become the preferred way for consumers to learn about new products and consume information, brands worried on how to make it possible with minimum impact to products and packaging recycling ability. Take in consideration a recent sales statistic founding that 43% of people want to see more video content from marketers and the current social media platform issues with bullying, hate that exposes brands and their customers, in addition to adversarial and competitors advertising being served along brands contents. Amid high competition for consumers attention on digital platforms, brands want to increase viewership of its contents and engagement with consumers to achieve greater ROI on their video investments.

Privacy is a growing trend, and the personalization of products powered by digital content, the Internet of Things, while highly desired, it needs to take in consideration consumers growing concerns with data mining of their activities. The personalization of products with unique video messages, with privacy and securely stored and transmitted are requirements for this innovation, particularly when addressing the needs in digital health, such as with the introduction of personalized prescription instructions in video. Personalized Prescription Instructions in video were unforeseen prior to this application's inherent patents. Most patients trash their prescription instructions without reading it, therefore not available when most needed. Most patients have difficulty reading the prescription instruction printed information, therefore making prescription instructions in video is a great improvement in educating patients on prescribed treatment and as well to increase their adherence to treatments.

Barcodes have been traditionally used for tracking products along the supply chain and providing product related information, which mostly addresses the needs of organizations but have little value for consumers. Desiring to leverage barcodes already printed on product's packaging, for the direct streaming of brand's videos, this invention creates a method for first engaging consumers through digital content streaming using barcodes associated with its unique identification, and giving them the ability for accessing product related information from a content engagement platform.

Prior to this invention gifts were detached from its messages, products from its assembly and use instructions. This invention enables the personalization of gifts with digital content, therefore keeping gifts and their video messages together.

The rise of blockchain technology creates a need for leveraging NFTs as one of the unique identification methods for the direct recording and streaming of digital contents from products, printed media, and digital assets.

Luxury brands desire to add digital contents to their products without compromising their packages aesthetic presentation often compromised with the use of one-dimensional and two-dimensional barcodes such as UPC and QR Codes, or its packaging recycling ability. This invention makes used of NFC, ZARImage and other technologies powered by AI Intelligent Imaging Processing and OCR to address this need.

How to engage consumers beyond content viewing in an integrated and customizable way? This invention also provides a method for offering users digital content engagement options associated with a digital content shown on a media player, and linked to product or digital asset.

### BRIEF SUMMARY OF THE INVENTION

This invention is in the field of Internet of Things and Mixed Reality. It enables the direct recording and streaming of digital contents from products or digital assets upon the scanning or capturing of encoded data, and the extraction or decoding of unique identifications, or unique links, associated with products, printed media or digital assets, without intervening steps.

The unique identification in this invention is encoded using visible or concealed technologies such as Barcode, QR Code, Datamatrix, NFC tags, ZARImage, and other technologies leveraging AI Imaging Processing and OCR technologies to encode and decode unique identification. The unique identifications used by this invention can be, but not limited to, the following types ZARCode, NFT, URL or URI.

This invention provides a method for creating and showing a customizable engagement platform for consumer engagement, overlaid to digital contents shown on mobile device media player, where said digital contents are associated with physical products, printed media, or digital assets.

This invention provides a method for the direct recording and streaming of digital content via mobile devices and mobile networks using a unique identification associated to a product barcode, capable of enabling digital content recording and streaming targeted to product's geolocation, viewer demographics, world events, calendar events, psychographics and social intelligence affinities.

This invention makes use of inherent patents to provide a more aesthetically pleasant representation of a code information attached to products, labels, packaging and digital assets for facilitating the direct recording and streaming of digital content using a unique identification.

### BRIEF DESCRIPTION OF THE SEVERAL VIEWS OF THE DRAWING

Features and advantages of the present invention will become apparent from the following description of pictures thereof, by way of example only, to the accompanying drawings, in which:

FIG. 1 shows the schematic diagram illustrating elements engaged in the unique identification based digital content direct creation and direct streaming from a products or digital assets using mobile device and over mobile network, where unique identification can be encoded using visible and concealed technologies such as QR Code, Datamatrix, NFC tags, ZARImage and other AI imaging processing technologies with OCR capabilities. The unique identification can be type ZARCode, NTF, URL and URI. Product's barcodes can also be used associated with unique identifications to allow the direct recording and streaming of videos. It also shows the customizable digital content engagement overlay on media player.

FIG. 2 shows the schematic diagram illustrating elements engaged in the unique identification based digital content direct creation and direct streaming from a products or digital assets with customizable digital content engagement overlay on top of media player.

FIG. 3 show examples of encoding technologies used for recording, embedding, or concealing the unique identifications used in this invention supporting the direct recording and streaming of digital contents associated with products or digital assets.

FIG. 4 shows example of unique identification type NFT encoded using visible and concealed technologies.

FIG. 5 shows how product barcode is associate with one or many digital contents linked to unique identification for the direct recording and streaming of digital contents from products.

FIG. 6 shows the workflow for message creations, digital content creation and association with unique identification enabling the direct streaming of digital contents from products, printed media, and digital assets.

FIG. 7 shows the workflow for message retrieval and the direct streaming of digital contents associated with unique identification embedded to products, printed media, and digital assets.

FIG. 8 shows the workflow for message creations from a product barcode, with digital content creation and association with unique identification enabling the direct streaming of digital contents from products, printed media, and digital assets.

FIG. 9 shows the workflow for message retrieval and the direct streaming of digital contents from a product barcode associated with unique identifications.

FIG. 10 shows the physical or digital asset authentication workflow using NFT blockchain technology or other unique identification types supported by this invention, such as ZARCode.

FIG. 11 shows the physical or digital asset authentication workflow using NFT blockchain technology or other unique identification types supported by this invention, such as ZARCode.

FIG. 12 shows workflow for bulk generation, or batch creation process of unique identification used by this invention to enable the direct recording and streaming of digital contents from products and digital assets, without intervening steps.

FIG. 13 shows workflow for on demand generation of unique identification used by this invention to enable direct recording and streaming of digital contents from products and digital assets, without intervening steps.

FIG. 14 shows workflow for managing the unique identifications used by this invention to enable direct recording and streaming of digital contents from products and digital assets, without intervening steps.

FIG. 15 shows examples of digital contents engagement overlays to the media player, where overlay can bed configured to be shown in the beginning of digital content streaming, and/or at the end of digital content streaming and/or during digital content streaming through user request and interaction with engagement overlay.

FIG. 16 shows that a product may be associated with different unique identification types, these unique identifications being associated with digital contents, and these digital contents possibility having customizable engagement options overlays to the media player direct streaming digital contents.

FIG. 17 shows the workflow supporting the creation of engagement options overlay enabling users to engage with digital contents directly streamed from products, printed media, and digital assets without intervening steps upon the decoding of unique identification.

FIG. 18 shows the workflow supporting the display of engagement options overlay upon the direct streaming of digital content to mobile devices media player, where mobile device can be a wearable device.

### DETAILED DESCRIPTION OF THE INVENTION

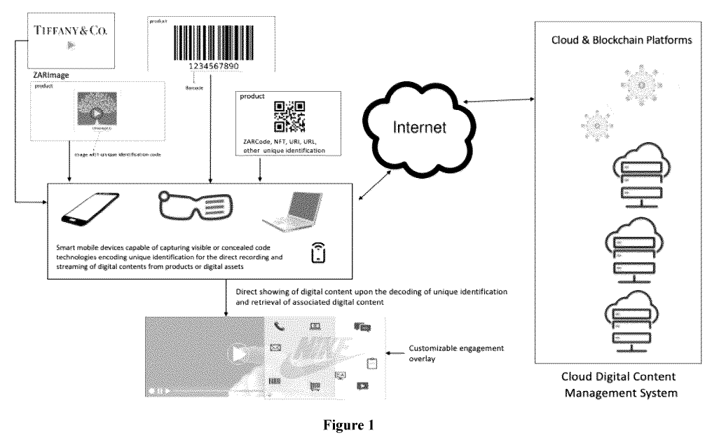

FIG. 1 shows the schematic diagram illustrating elements engaged in direct creation and direct streaming of digital contents from products or digital assets using unique identification, by means of mobile devices capable of capturing encoded unique identifications and executing its processes over mobile networks, where unique identification can be encoded using visible and concealed technologies such as QR Code, Datamatrix, NFC tags, ZARImage and other AI imaging processing technologies with OCR capabilities. The unique identification can be represented using ZARCode, a technology from related prior patent application, NTF, unique URL and URI technologies, but not limited to them. Product's barcodes can also be used for the direct recording and streaming of digital contents when associated with unique identifications supporting this invention. Brands can leverage existing products packaging to enable the direct streaming of their video advertisements and products instructions in video. This invention also allows for the creation and showing of customizable engagement options overlay to digital contents media player. Options for engagement can include but not limited to websites, social media channels, phone number, emails, Application Protocol Interfaces (APIs), barcode integration for further product information with optional integration to GS1 datalink. The engagement overlay may have a background image, a logo or product image uploaded for its background with initial opacity level determined by the user creating the message. Engagement options have icons that can be resized and positioned on the content overlay as desired by the message creator. The engagement option titles, icons and activation links are customizable. Unique identifications using NFT makes uses of blockchain technologies.

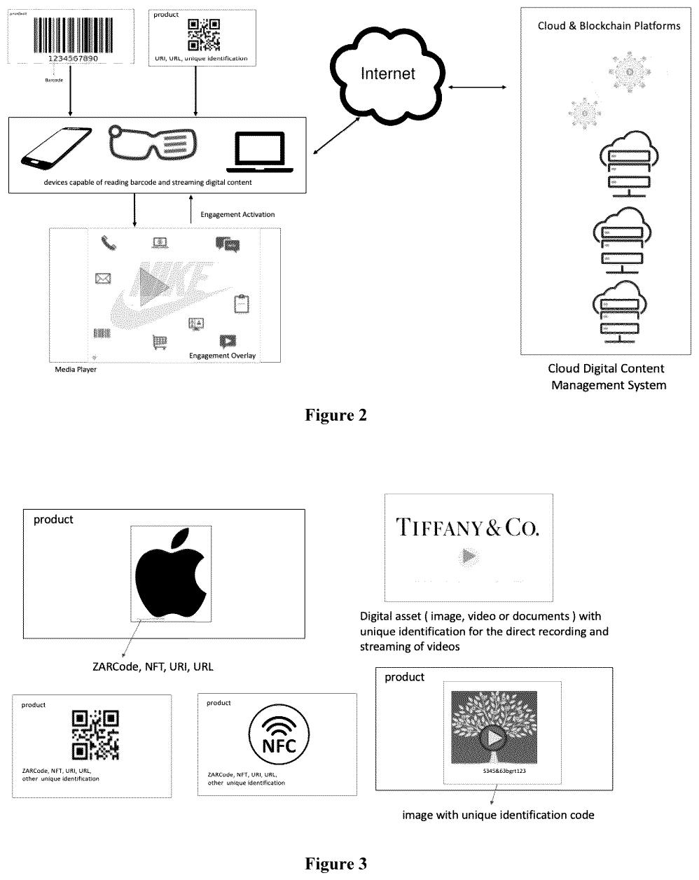

FIG. 2 shows the schematic diagram illustrating elements engaged in the direct record and streaming of digital contents from products and digital assets by leveraging unique identification encoded using visible and concealed technologies with a customizable platform for consumer engagement that is overlayed to mobile device media player for digital content shown. A customizable engagement platform can be defined for each digital content uploaded, to allow content viewers to engage by accessing product information, creating message replies, buying product, social sharing, accessing website, support and other engagement options set during message creation.

The customizable engagement overlay can be shown on the beginning of digital content streaming, at the end of digital content streaming or at any time during the digital content streaming through user action pulling down engagement overlay. In this figure the engagement overlay is covering the media player display area. Users can adjust overlay opacity to view digital content showing on media player.

FIG. 3 show examples of encoding technologies used for recording, embedding, or concealing unique identifications used in this invention supporting the direct recording and streaming of digital contents associated with products or digital assets. Technologies used for encoding and decoding of unique identification are listed but not limited to two-dimensional barcodes, NFC tags, RFID tags, ZARImage, AI Imaging processing technologies with OCR capability.

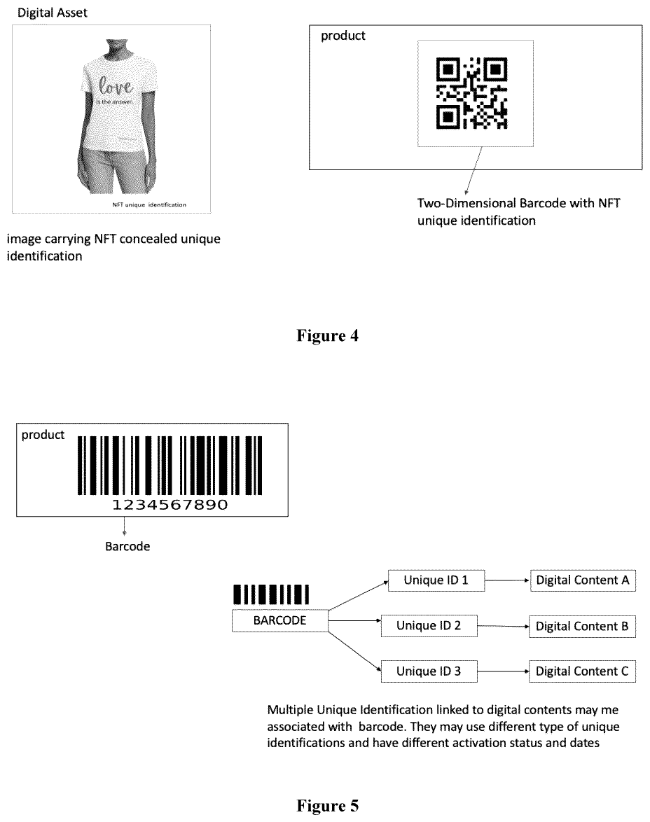

FIG. 4 shows this invention use of Non-Fungible Tokens (NFT) encoded using visible and concealed technologies for the direct recording and streaming of digital contents from products, printed media, and digital assets.

FIG. 5 shows how product barcode is associate with one or many digital contents linked to unique identifications for the direct recording and streaming of digital contents from products.

A method and apparatus for the direct recording and streaming of digital content via mobile devices and mobile networks from a unique identification associated to a product barcode is disclosed. In an embodiment, a product provider barcode is linked to unique keys enabling digital content storage, retrieval, and the direct streaming to the users mobile device media player. A mobile user of the application as a message creator scans a product barcode, and barcode information is sent to a cloud digital content management system to validated if user is authorized to create digital content for this barcode. A brand manager is an example of person that would be authorized to record digital contents to a product barcode. If user is authorized, then it proceeds to associate barcode to a unique identification and to enable the recording or uploading of digital contents. Digital contents recorded or uploaded can be targeted for streaming based on geolocation, demographics, events, psychographics, and social intelligence affinities. Digital contents associate to a Barcode and unique identifications have activation and deactivation dates set and updated by authorized user.

A product barcode can have one or more digital content associated with it and they are saved to this invention cloud digital content management system linked to unique identification data.

A mobile user of an application as recipient scans a product barcode, sends barcode information along with other available identifiable information to allow the cloud digital content management system to determine if barcode is linked to unique identifications supporting the direct streaming of digital contents, and intelligently determines the best digital content to retrieve and show using messages' targeted parameters such as geolocation, demographics, events, psychographics, and social intelligence affinities, and as well activation and deactivation dates set by message creator.

This targeted unique identification is now used for message retrieval and the direct streaming of digital content without intervening steps for the scanned barcode. The selected message's engagement overlay menu becomes available from mobile device media player and allows viewers to access product information, create message replies, save to their personal library, buy product, social sharing, access to websites, access support, interact with other applications and other engagement options set during message creation.

A Digital Content Management System is responsible for the management of barcode and unique identification information supporting this functionality.

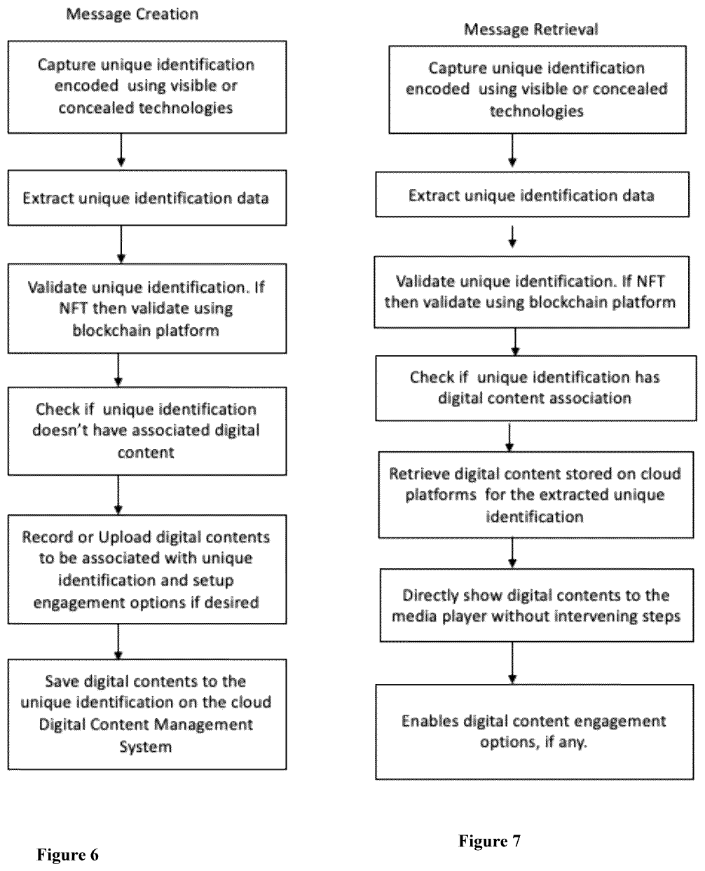

FIG. 6 shows the workflow for message creations, digital content creation and association with unique identification enabling the direct streaming of digital contents from products, printed media, and digital assets made of the following steps: 1). Capture unique identification encoded using visible or concealed technologies; 2) Extract unique identification data; 3) Validate unique identification. If NFT then validate using blockchain platform; 4) Check if unique identification doesn't have associated digital content; 5) Record or Upload digital contents to be associated with unique identification and setup engagement options if desired; 6) Save digital contents to the unique identification on the cloud Digital Content Management System.

FIG. 7 shows the workflow for message retrieval and the direct streaming of digital contents associated with unique identification embedded to products, printed media, and digital assets made of the following steps: 1) Capture unique identification encoded using visible or concealed technologies; 2) Extract unique identification data; 3) Validate unique identification. If NFT then validate using blockchain platform; 4) Check if unique identification has digital content association; 5) Retrieve or obtain digital content stored on cloud platforms for the extracted unique identification; 6) Directly show digital contents to the media player without intervening steps; 7) Enables digital content engagement options, if created for the digital content.

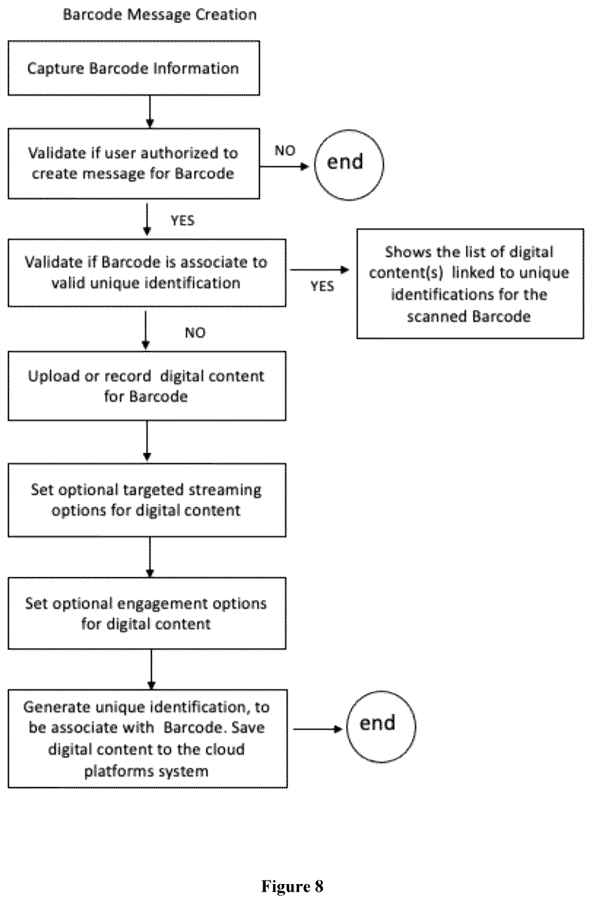

FIG. 8 shows the workflow for message creations from a product barcode, with digital content creation and association with unique identification enabling the direct streaming of digital contents from products, printed media, and digital assets made of the following steps: 1) Capture Barcode Information; 2) Validate if user authorized to create message for Barcode. Only users authorized by a brand owner can create digital contents associated to a product barcode owned by a brand; 3) Validate if Barcode is associate to valid unique identifications; if yes then shows a list of digital content(s) linked of digital contents with a unique identification associated to the scanned barcode and allow user to manage these digital contents by adding, deleting, updating digital content and targeting information. Digital contents recorded or uploaded in association with a barcode can be targeted for streaming based on geolocation, demographics, events, psychographics, and social intelligence affinities. Digital contents associate to a barcode and unique identifications have activation and deactivation dates that determines when digital content can start streaming and when it end streaming for scanned barcodes; 4) if barcode doesn't have yet a unique identification associated to it then enables the upload or record of digital content for the barcode; 5) Set optional targeted streaming options for digital content such as geolocation, demographics, events, psychographics, social intelligence and activation dates limits for beginning and ending its direct streaming from a barcode scanning; 6) Set optional engagement options for digital content created; 7) Generate unique identification to be associate with scanned barcode. Save digital content to the cloud platforms for the digital contents management system.

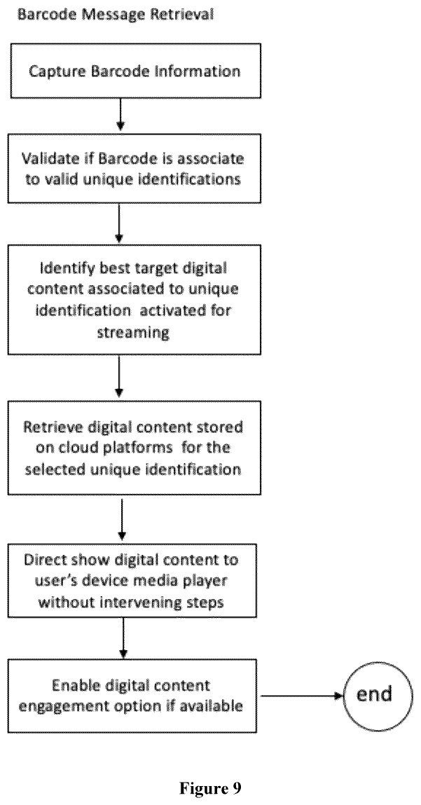

FIG. 9 shows the workflow for message retrieval and the direct streaming of digital contents from a product barcode associated with unique identifications made of the following steps: 1) Capture Barcode Information; 2) Validate if Barcode is associate to valid unique identifications; 3) Identify the best target digital content associated to unique identification activated for streaming using AI ML process; 4) Retrieve digital content stored on cloud platforms for the selected unique identification; 5) Direct show digital content to user's device media player without intervening steps; 6) Enable digital content engagement option if available.

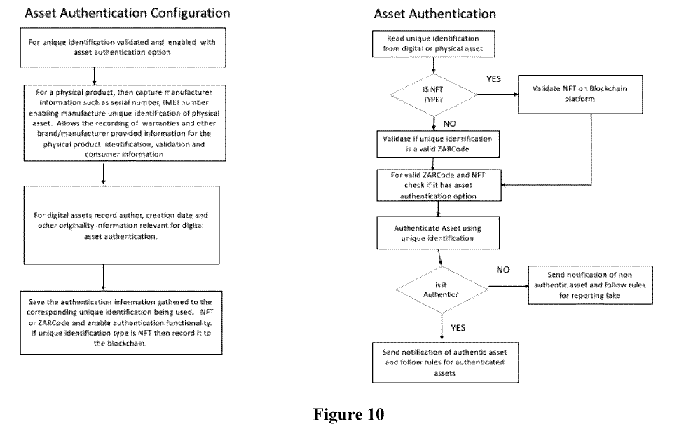

FIG. 10 The use of unique identification uniquely associated to a product unit or digital asset allows for their authentication. This workflow shows how physical or digital asset authentication happens in this invention, can it be using NFT blockchain technology or other unique identification types supported by this invention, such as ZARCode. The workflow consists of the following steps: 1) Read unique identification from digital or physical asset; 2) Check if unique identification is type NFT and validate it on the blockchain; 3) If not NFT then validates if it is a valid ZARCode or other unique identification supported by this invention; 3) For valid ZARCode and NFT check if it has asset authentication option; 4) if a valid NFT or valid ZARCode with authentication option enabled, then Authenticate Asset using the unique identification against authentication parameters provided by manufacturers, brands, and owners during product registration. 5) If asset isn't authentic then send notification of non-authentic asset and follow rules for reporting fake. Create an auditing transaction; 6) If asset is authentic then follow rules for authenticated assets, such as showing seal of authentication symbol and any other customizable information configured by manufacture or brand owner.

The asset authentication configuration is defined by manufacture or brand owner to unique identifications assigned to physical products and digital assets, and they consist of the following steps: 1) Validated unique identification and verify it has asset authentication option; 2) For a physical product, then capture manufacturer information such as serial number, IMEI number enabling manufacture unique identification of physical asset. Allows the recording of warranties and other brand/manufacturer provided information for the physical product identification, validation and consumer information; 3) For digital assets record author, creation date and other originality information relevant for digital asset authentication; 4) Save the asset authentication information gathered to the corresponding unique identification being used, NFT or ZARCode, and enable authentication functionality. If unique identification type is NFT then record it to the blockchain.

Asset authentication is an option selected by brands owners, manufactures and digital art creators to uniquely identify a product unit or a digital art original. They must be uniquely assigned to a physical product or digital asset. The cloud content management system and its Asset Authentication and Monitoring applications are responsible for monitoring fake and fraudulent use unique identifications assigned for asset authentication.

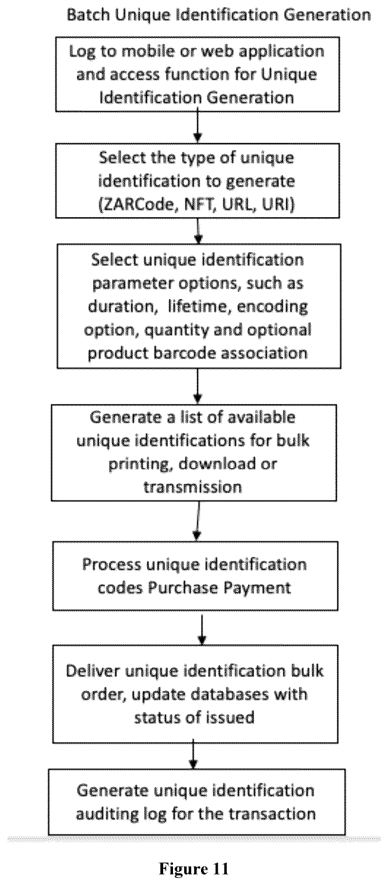

FIG. 11 shows workflow for bulk generation, or batch creation process of unique identification used by this invention to enable the direct recording and streaming of digital contents from products and digital assets, without intervening steps. The workflow consists of the following steps: 1) Log to mobile or web application and access function for Unique Identification Generation; 2) Select the type of unique identification to generate (ZARCode, NFT, URL, URI); 3) Select unique identification parameter options, such as duration, lifetime, encoding option, quantity and optional product barcode association; 4) Generate a list of available unique identifications for bulk printing, download or transmission; 5) Process unique identification codes purchase transaction; 6) Deliver unique identification bulk order as selected by user and update databases with status of issued. 7) Generate unique identification auditing log for the transaction.

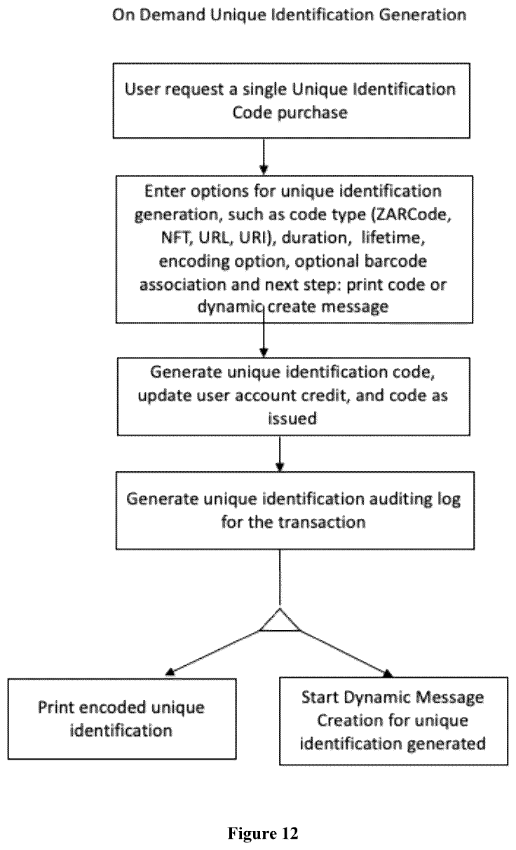

FIG. 12 shows workflow for on demand generation of unique identification used by this invention to enable direct recording and streaming of digital contents from products and digital assets, without intervening steps. The workflow consists of the following steps: 1) User request a single Unique Identification Code purchase; 2) Enter options for unique identification generation, such as code type (ZARCode, NFT, URL, URI), duration, lifetime, encoding option, optional barcode association and next step: print code or dynamic create message; 3) Generate unique identification code with selected encoding technology and output options, such as to print or to initiate message creation. Update user account credit, and updated code as issued; 4) Generate unique identification auditing log for the transaction; 5) If output option is Print then enable user to print, download or share encoded unique identification. 6) If output option was to start the creation of message, digital content, then start Dynamic Message Creation for the unique identification generated.

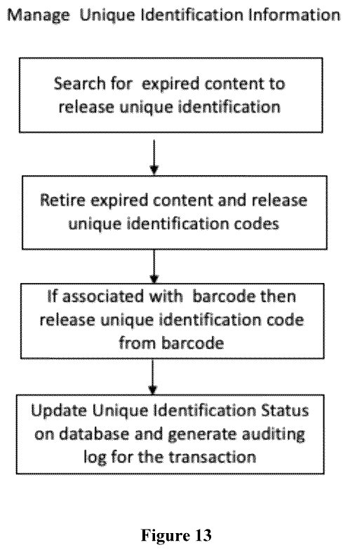

FIG. 13 shows workflow for managing the unique identifications used by this invention to enable direct recording and streaming of digital contents from products and digital assets, without intervening steps. It consists of the following steps: 1) Search for expired content to release unique identification; 2) Retire expired content and release unique identification codes; 3) If associated with barcode then release unique identification code from barcode; 4) Update Unique Identification Status on database and generate auditing log for the transaction.

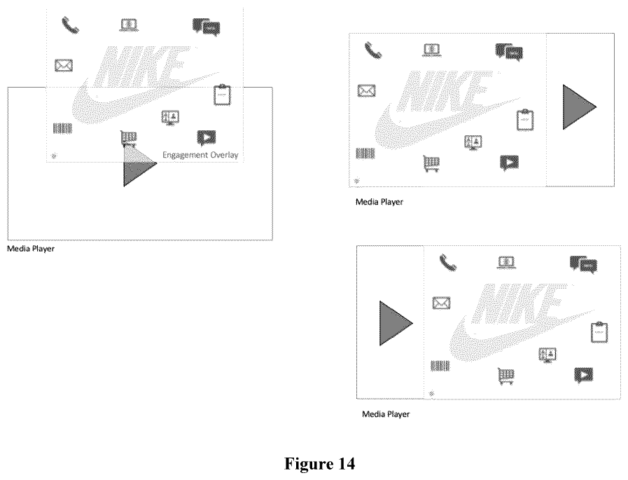

FIG. 14 shows examples of digital contents engagement overlays to the media player, where overlay can be configured to be shown in the beginning of digital content streaming, and/or at the end of digital content streaming and/or during digital content streaming through user request and interaction with engagement overlay. The digital content customizable engagement platform has several options to be selected by users such as the ability for linking websites, social media platforms public profiles and channels, enable email communication, phone calls, delivering product information associated to its barcode, link to e-commerce sites, the generation of message replies by viewers, enabling the saving of liked digital contents to a registered user personal library, real-time analytics on content viewing and engagement, purchase of product, social sharing, access to promotions and rewards, access to support, interact with other applications such as those providing products review and surveys. A background image or logo can be uploaded for the engagement overlay, with its opacity, engagement icons positions and size on overlay chosen by message creator. Engagement options design and activation can be previewed and tested during message creation.

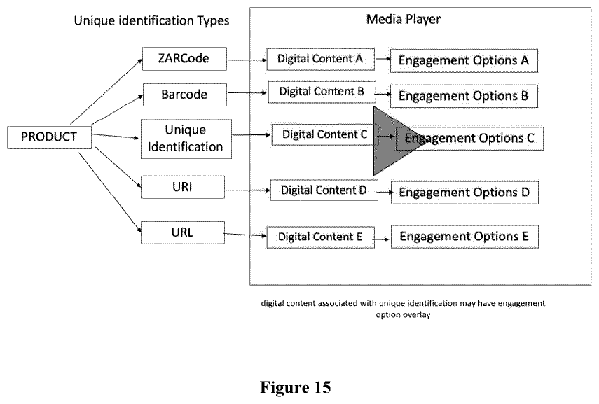

FIG. 15 shows that a product may be associated with different unique identification types, these unique identifications being associated with digital contents, and these digital contents possibility having customizable engagement options overlays to the media player direct streaming digital contents.

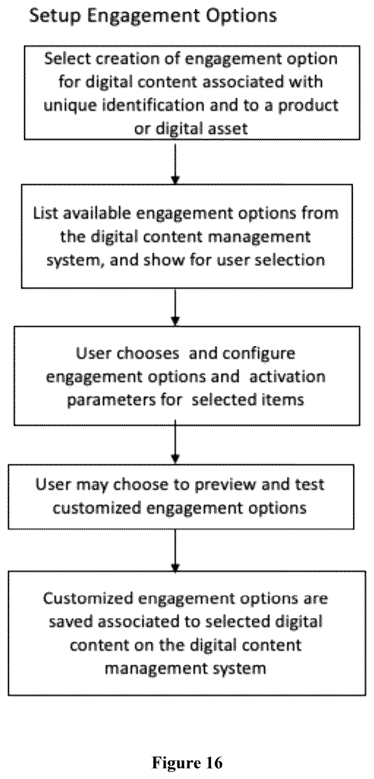

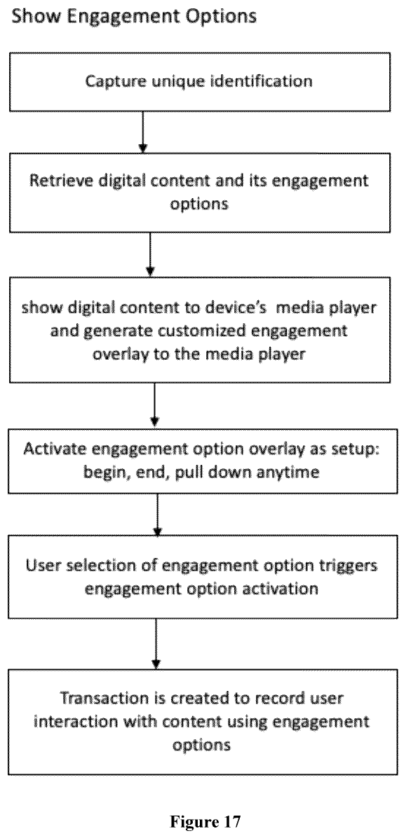

FIG. 16 shows the workflow supporting the creation of engagement options overlay enabling users to engage with digital contents directly streamed from products, printed media, and digital assets without intervening steps upon the decoding of unique identification. The workflow consists of the following steps: 1) Select creation of engagement option for digital content associated with unique identification and to a product or digital asset; 2) List available engagement options from the digital content management system, and show for user selection; 3) User chooses and configure engagement options and activation parameters for selected items; 4) User may choose to preview and test customized engagement options; 5) Customized engagement options are saved associated to selected digital content on the digital content management system.

FIG. 17 shows the workflow supporting the display of engagement options overlay upon the direct streaming of digital content to mobile devices media player, where mobile device can be a wearable device. The workflow consists of the following steps: 1) Capture unique identification; 2) Retrieve digital content and its engagement options; 3) show digital content to device's media player and generate customized engagement overlay to the media player; 4) Activate engagement option overlay as setup: begin, end, pull down anytime; 5) User selection of engagement option triggers engagement option activation; 6) Transaction is created to record user interaction with content using engagement options.

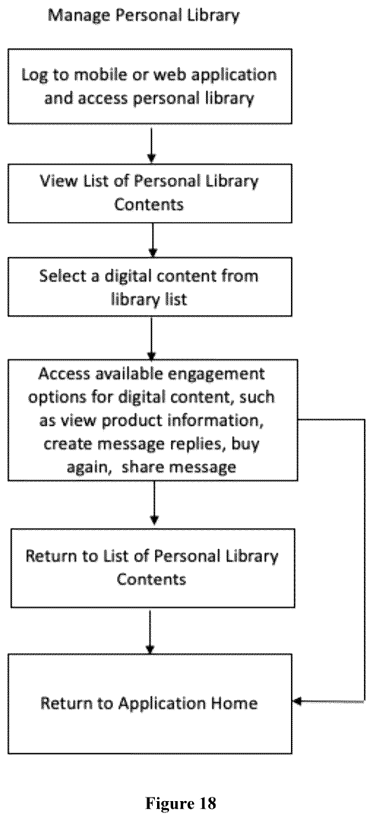

FIG. 18 shows the workflow for the management of the personal library by a registered user. The workflow consists of the following steps: 1) Log to mobile or web application and access personal library; 2) View List of Personal Library Contents; 3) Access options for engaging with contents listed

What is claimed is:

1. A customer apparatus for facilitating digital content creation and
the direct digital content streaming from a product provider artifact carrying a unique identification, comprising:
a method operatively hosted on a mobile device, the mobile device comprising at least one mobile device processor operatively connected to at least one cloud digital content management system via a mobile telecommunication network, wherein the at least one mobile device processor is configured to:
capturing a visible or concealed encoded information and extracting unique identification data;
validating unique identification data to allow the direct recording and/or direct streaming of digital contents;
creating digital content and associating digital content with the unique identification;
retrieving digital content from the at least one cloud digital content management system upon the extraction and validation of unique identification;
directly streaming digital content obtained from the at least one cloud digital content management system via the mobile telecommunication network upon the reading of unique identification.

2. The method in accordance with claim 1, wherein the at least one mobile device processor is configured for reading visible unique identification such as those encoded to QR Code, Datamatrix and Barcodes on a product provider artifact for the direct recording and streaming of digital content.

3. The method in accordance with claim 1, wherein the at least one mobile device processor is configured for reading concealed unique identification such as those recorded to NFC tags, embedded to ZARImage and encoded to QE Code on a product provider artifact for the direct recording and streaming of digital content.

4. The method in accordance with claim 1, wherein the unique identification can be type NFT token, ZARCode, URI and URL.

5. The method in accordance with claim 1, wherein the digital content has a customizable engagement options platform as an overlay to the mobile device media player for digital content engagement upon its streaming.

6. The customer apparatus in accordance with claim 1, wherein the mobile device reads the product provider artifact unique identification and enables the creation of digital content associated with said unique identification.

7. The customer apparatus in accordance with claim 1, wherein the
mobile device reads the product provider artifact unique identification and enables the direct streaming of digital content associated with said unique identification.

8. A method for facilitating digital content creation and the direct digital content streaming from a product provider artifact or digital asset carrying a unique identification, comprising:
a method operatively hosted on a mobile device, the mobile device comprising at least one mobile device processor operatively connected to at least one cloud digital content management system via a mobile telecommunication network, wherein the at least one mobile device processor is configured to:
extracting unique identification encoded to digital assets or to product provider artifacts using visible and concealed code technologies;
validating unique identification data to allow the direct recording and/or direct streaming of digital contents;
creating digital content and associating digital content with the unique identification;
retrieving digital content from the at least one cloud digital content management system upon the decoding and validation of unique identification;
directly streaming digital content obtained from the at least one cloud digital content management system via the mobile telecommunication network upon the reading of unique identification.

9. The method in accordance with claim 8, wherein the unique identification can be type NFT token, ZARCode and URI.

10. The method in accordance with claim 8, wherein the digital content has a customizable engagement options platform as an overlay to the mobile device media player for digital content engagement upon its streaming.

11. A method for facilitating digital content creation and the direct digital content streaming from a product provider artifact carrying a product barcode associated with at least one unique identification, comprising:
a method operatively hosted on a mobile device, the mobile device comprising at least one mobile device processor operatively connected to at least one cloud digital content management system via a mobile telecommunication network, wherein the at least one mobile device processor is configured to:
reading barcode on product provider artifacts;
retrieving unique identifications associated with barcode;
validating unique identification to allow the recording and/or direct streaming of digital contents associated with barcode;
creating digital content and associating digital content with the unique identification linked to barcode;
retrieving digital contents associated with barcode from the at least one cloud digital content management system upon the retrieval and validation of unique identification;
directly streaming digital content obtained from the at least one cloud digital content management system via the mobile telecommunication network upon the reading of unique identification associated with barcode.

12. The method in accordance with claim 11, wherein the unique identification associated with barcode can be type NFT token, ZARCode and URI.

13. The method in accordance with claim 11, wherein the digital content has a customizable engagement options platform as an overlay to the mobile device media player for digital content engagement upon its streaming.

14. The customer apparatus in accordance with claim 1, wherein said
cloud digital content management system is for processing mobile application transactions over the mobile telecommunication network, for the administration, generation, and storage of digital content and unique identification key associated with a product provider artifact.

15. The method in accordance with claim 8, wherein said
cloud digital content management system is for processing mobile application transactions over the mobile telecommunication network; for the administration, generation, and storage of digital content and unique identifications associated with a product provider artifact or digital asset.

16. The method in accordance with claim 11, wherein said
cloud digital content management system is for processing mobile application transactions over the mobile telecommunication network; for the administration, generation, and storage of digital content and unique identifications associated with a product barcode.
